(19) United States
(12) Patent Application Publication
(10) Pub. No.: US 2002/0116221 A1
(43) Pub. Date: Aug. 22, 2002

(54) Chronic illness treatment system and method

(76) Inventors: Martin J. Fields, Chicago, IL (US); Glenn H. Mason, Iselin, NJ (US); Rex E. Thexton, Branchburg, NJ (US)

Correspondence Address: PATENT ADMINSTRATOR, KATTEN MUCHIN ZAVIS ROSENMAN, 525 WEST MONROE STREET, SUITE 1600, CHICAGO, IL, 60661-3693, US

(21) Appl. No.: 09/790,133

(22) Filed: Feb. 21, 2001

Related U.S. Application Data
(60) Provisional application No. 60/243,590, filed on Oct. 26, 2000.

(51) Int. Cl. G06F 17/60

(52) U.S. Cl. 705/2

(57) ABSTRACT

A system and method are disclosed for providing comprehensive, community-based and related support services to chronically ill patients and their caregivers. The system and method create a computer network based support system that centralizes the biopsychosocial treatment of the chronically ill patient within the patient's or caregiver's home. The system and method provide the patient and caregiver with all the necessary resources, support services and support networking to conduct this treatment. The system and method allow chronically ill people to make comprehensive lifestyle changes to enhance their quality of life and reduce the depression and anxiety that is created by having such a debilitating chronic illness.

### CROSS-REFERENCE TO RELATED APPLICATIONS

This application claims the benefit of U.S. Provisional Application No. 60/243,590, filed Oct. 26, 2000, which is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Proper medical care usually involves two main components: clinical treatment and some form of related caregiving. With non-chronic illnesses, these two steps are relatively straight forward and usually quite effective. With non-chronic illnesses, the medical practitioner (e.g., a doctor or a nurse) usually performs a series of diagnostic procedures, such as examining the patient, conducting lab tests, making a physical diagnosis of the patient, and, based on the results of these test and diagnoses, he or she is usually able to determine a course of action for treating the illness, such as prescribing medication, performing surgery or suggesting some other form of treatment for the illness. The caregiving required for such non-chronic illnesses is usually relatively minimal and for a relatively short period of time (e.g., a certain period of bed rest required after surgery, taking the prescribed medication for fixed period of time).

Treatment of chronic illnesses is not as straightforward. Chronic illnesses, by their nature, are complex, long term diseases that cannot be remedied simply by providing some form of clinical treatment. Rather, chronic illnesses have psychological and sociological symptoms, as well as physical symptoms, that must be addressed as well. As such, with chronic illnesses, clinical treatment of the disease is minimal relative to the amount of caregiving required. The exact opposite of what is required to treat non-chronic illnesses. Unfortunately, for chronically ill patients, medical practitioners, in addition to providing the clinical treatment services which they are best suited for, are usually also called on to provide the caregiving services as well, a role they are not especially well suited for. Medical practitioners are not especially well suited for providing caregiving services because of the relatively high costs of their services, the significant time and attention that chronically ill patients require and the medical practitioner's time commitments to other things (e.g., clinical care). As such, since medical practitioners cannot provide effective long-term caregiving services for chronically ill people, chronically ill people in these situations get caught in a vicious cycle where the patient keeps feeling more and more hopeless, frustrated and depressed because he or she cannot get the support and guidance he or she needs.

Prior systems have been developed that focus on providing long-term in-home health care services, such as the system described in International Publication No. WO 98/20439, entitled “System for Providing Comprehensive Health Care and Support” filed by Roman. Long-term in-home health care systems such as this, however, focus on supporting and addressing the long term clinical aspects of treating a disease, such as monitoring blood pressure, taking fluid samples and providing educational materials related to such clinical aspects of the disease. These systems do not focus on providing long-term caregiving to chronically patients and, consequently, do not focus on creating a caregiving support community and network. This is evidenced by the description provided in Roman on page 19, ln. 6-page 22, ln. 26 which discusses providing on-line, health care provider initiated clinical visits which follow treatment programs developed by the patient's doctor. The patient is not involved in the process of developing the treatment program nor is the patient able to conduct activities with the system without the assistance of the assigned health care provider. In a long-term caregiving system, the patient needs to have more flexibility and opportunity in helping develop the program and in interacting with the system when they need to.

Accordingly, there is a need for a system and method that provides chronically ill patients with cost effective, comprehensive long term treatment and caregiving services.

### SUMMARY

It is an object of the present invention to provide a comprehensive, community-based support network and services for chronically ill patients and their caregivers.

It is an object of the present invention to provide a system and method that centralizes the biopsychosocial treatment of chronically ill patients within the patient's home by providing the patient and his or her caregiver with all the necessary resources, support services and support networking to accomplish this task.

It is an object of the present invention to provide a system and method that can be provided over a computer network system, such as the Internet, which allows chronically ill people to make comprehensive lifestyle changes to enhance their quality of life and reduce the depression and anxiety that is created by having such a debilitating disease.

### BRIEF DESCRIPTION OF THE DRAWINGS

These and other features, aspects, and advantages of the present invention will become better understood with regard to the following description, appended claims, and accompanying drawings where:

FIG. 1 depicts an operating environment in which the system and method of the present invention may operate;

FIG. 2 illustrates an exemplary six stage treatment model that the system and method of the present invention may be based on;

FIG. 3 illustrates an exemplary process that a chronically ill patient in a treatment program of the present invention may go through;

FIG. 4 illustrates a process flow for an exemplary scheduled activity;

FIG. 5 depicts an exemplary main web page for interacting with the treatment program of the present invention;

FIGS. 6A-C depict an exemplary main web page for a selected disease;

FIGS. 7A-B depict an exemplary sign up questionnaire page of the present invention;

FIG. 8 depicts an exemplary summary assessment page;

FIGS. 9A-B depict an exemplary activities list;

FIG. 10 depicts an exemplary activity schedule;

FIG. 11 depicts an exemplary treatment protocol;

FIG. 12 depicts an exemplary chat room;

FIG. 13 depicts an exemplary journal entry screen;

FIG. 14 depicts an exemplary progress data entry screen;

FIG. 15 depicts an exemplary visual representation of the patient's progress; and

FIG. 16 depicts an exemplary chat room listing.

### DETAILED DESCRIPTION OF THE INVENTION

### System Environment

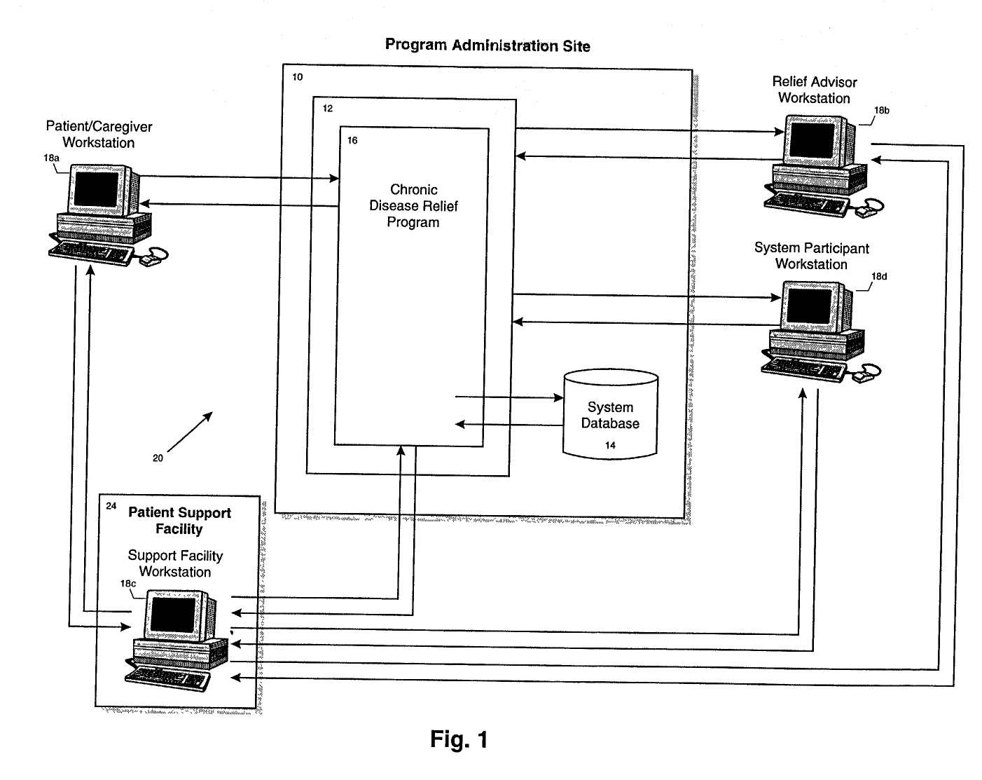

Referring to FIG. 1, the system and method of the present invention operates primarily in a computer network environment. In this embodiment, the system 20 includes a program administration site 10 which includes a server computer 12 and a system database 14 and a number of system workstations 18 that communicate with the server computer 12. The workstations 18 may be used by patients/caregivers 18a, relief advisors 18b, support facility users 18c or any other system participant 18d. The workstation 18 may be a personal computer (PC) or any device capable of interacting with a computer network, including such devices as personal digital assistants (PDA) and cellular phones. Resident on the server computer 12 of the system 20 is a chronic disease relief program 16. The system 20 may also include a patient support facility 24 which provides patient support services to patients in the treatment program of the present invention.

### System and Program Model

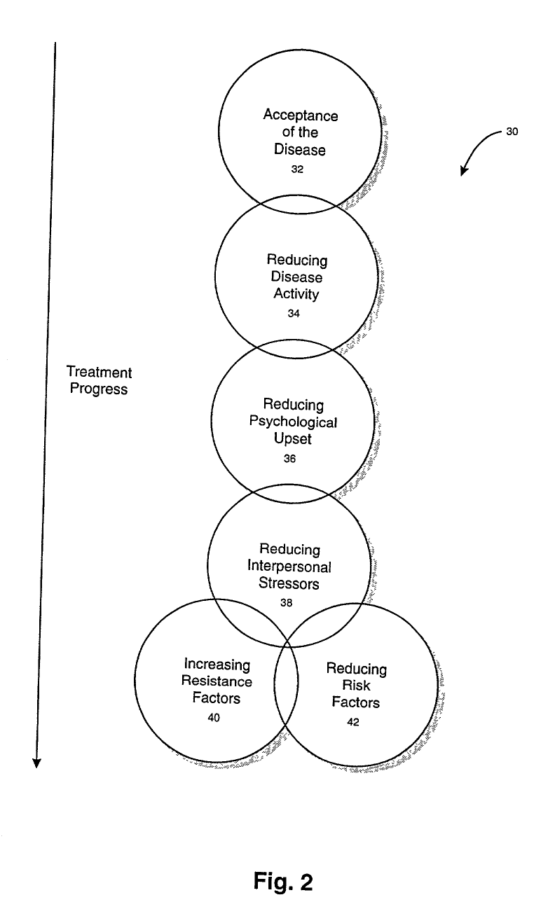

The system 20 and the chronic disease relief program 16 may be based on any technique or model that is used to treat chronically ill patients. Referring to FIG. 2, in the preferred embodiment, the system 20 and chronic disease relief program 16 are based on an effective six stage chronic disease recovery model 30. In the model 30, the chronically ill patient: 1) learns to accept the disease 32; 2) learns to reduce disease activity 34; 3) learns to reduce the things that make him or her psychologically upset 36; 4) learns to reduce interpersonal stressors 38; 5) learns to increase resistance factors 40 and 6) learns to reduce risk factors 42.

In the first stage, acceptance of the disease 32, the patient comes to terms with his or her chronic illness and finally accepts that the disease is more than likely a life long illness with no immediate cure and finally understands that the constant search for the latest pill or the doctor with the previously untried cure is, for the most part, futile. With this realization, the patient can now focus on improving his or her life in the context of living with the disease. In the second stage, reducing the disease activity 34, the patient focuses on learning strategies to deal with the disease, such as learning ways to cope and reduce the symptoms of the disease and leaning how to manage the disease and not rely so heavily on medications. In the third stage, reducing psychological upsets 36, the patient learns how to use and rely on social and psychological support mechanisms to cope with the disease. In the fourth stage, reducing interpersonal stressors 38, the patient learns a whole range of coping skills for dealing with day to day problems, learns how to set goals that bring satisfaction in spite of the disease and learns how to utilize the strengths developed in coping with the disease to his or her benefit. In the fifth stage, increasing resistance factors 40, the patient is assisted in developing a new lifestyle that takes the disease into account and establishes realistic and uplifting goals for the patient to achieve. In the sixth stage, reducing risk factors 42, the patient is assisted in dealing with the inevitable depression and anxiety that inherently accompanies the change in lifestyle required to accommodate the disease.

For the most part these stages are sequential, but as indicated by the Venn diagrams in FIG. 2, there is some overlap between the stages, especially as the patient progresses with his or her treatment. This makes sense because a patient, obviously, cannot start learning how to self manage the disease which is necessary in the second stage 34, reducing the disease activity, until the patient comes to terms with his or her disease in the first stage 32, acceptance of the disease.

### System and Method Process Flow

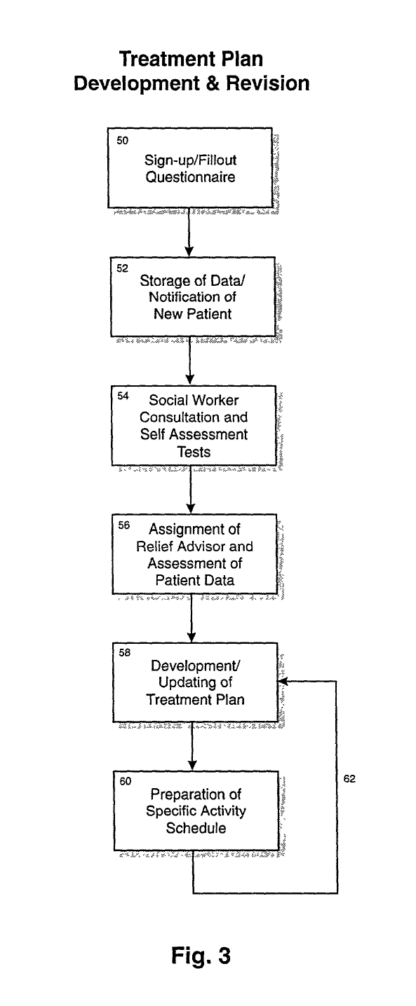

FIG. 3 illustrates the process that a chronically ill patient in the treatment program of the invention goes through during the six stages of treatment. (A patient's caregiver can also use the treatment program of invention as described herein to aid the patient. As such, where this disclosure describes a “patient” performing some action in the treatment program process, these actions are equally applicable to a “caregiver” as well.) The chronic disease relief program 16 is the focal point for executing each one of these steps and serves to guide the chronically ill patient through the treatment program. As indicated at step 50, a new patient to the treatment program first needs to sign-up and fill out a questionnaire. Once submitted, as indicated at step 52, the completed questionnaire is processed by the chronic disease relief program 16 which stores the questionnaire data to the system database 14 and notifies the treatment program administrator of the new patient. In the preferred embodiment, the treatment program administrator has a treatment program social worker contact the new patient to conduct an initial consultation interview and some self assessment tests, as indicated at step 54. At step 56, a relief advisor is assigned who compiles the assessment data and provides the patient with a summary of the assessment. The relief advisor is a trained counselor. In the preferred embodiment, the relief advisor has a master's degree in counseling and has undergone a training program most likely developed by a panel of experts in the disciplines of medicine, psychology and psychotherapy, social work, occupational and physical therapy and law. Such training provides the relief advisor with the expertise needed to address the needs of the chronically ill. Each patient in the treatment program has a primary relief advisor and a number of alternates so that each patient in the treatment program has relief coverage at all times, twenty-four hours a day, seven days a week. At step 58, the relief advisor and the patient work together to develop a treatment plan with specified goals. At step 60, the relief advisor and the patient develop a set of specific activities, and schedule them, to accomplish the established treatment goals. As line 62 indicates, the relief advisor and the patient are constantly reassessing and updating the treatment plans and goals to keep advancing the patient through the six stages of treatment.

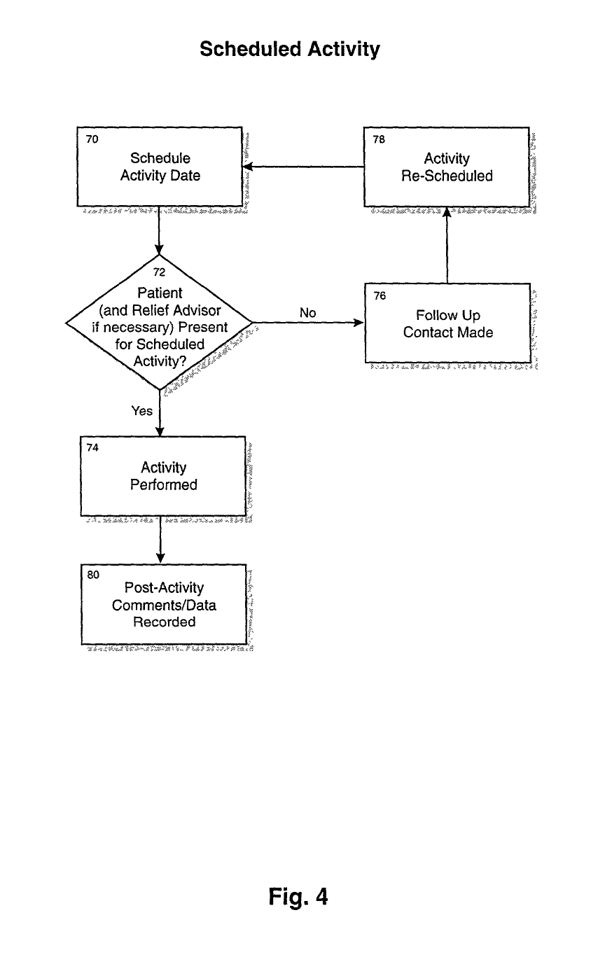

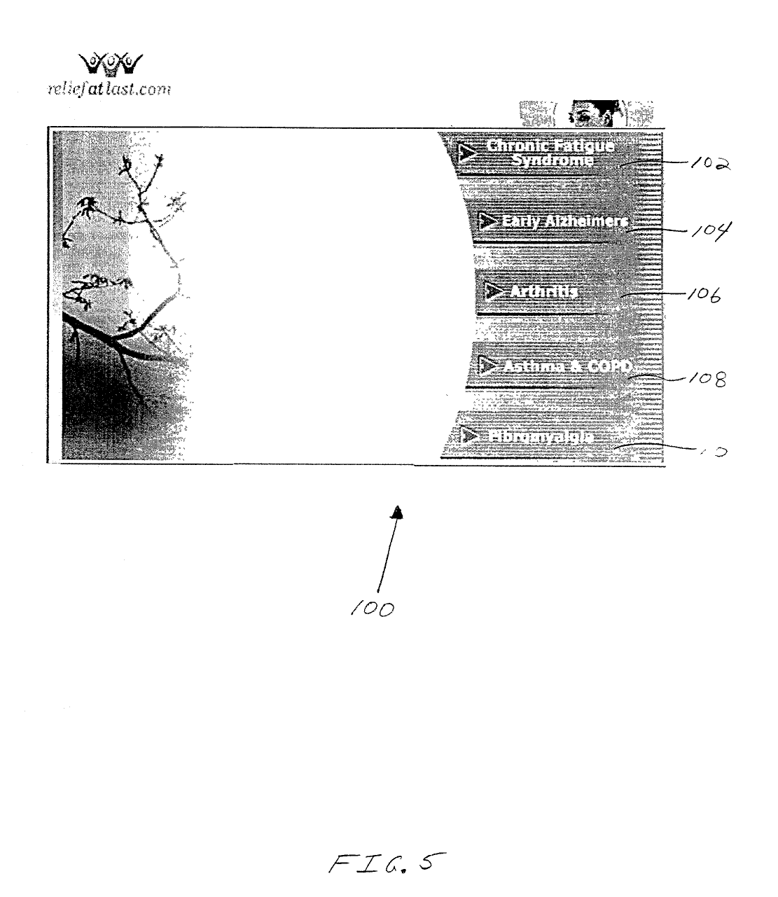

FIG. 4 illustrates the process flow for a scheduled activity. At the time of a scheduled activity (block 70), as indicated at step 72, the chronic disease relief program 16 checks to see if the patient, and if necessary the relief advisor, are present. If yes, then the scheduled activity is conducted at step 74. If not, follow up contact is made with the patient and the activity is re-scheduled as indicated at steps 76 and 78. As indicated at step 80, once the scheduled activity is finished, the patient is asked to provide post-activity comments and data.

Another feature of the system 20 is that the treatment provided by the chronic relief program 16 is integrated with and supported by various patient support facilities 24. If the patient feels he or she needs to see a specialist for whatever reason or the relief advisor believes the patient needs such services, the patient or the relief advisor can contact an integrated patient support facility 24 and schedule a session with a specialist. The advantage of using a specialist who is part of the system is that the specialist will know exactly where the patient is in their treatment program and can then counsel him or her accordingly without having to waste a lot of time. These sessions can take place in a variety of places: the patient support facility 24, the patient's home or any location that is convenient for the specialist and the patient (e.g., a caregiver's residence). The specialists that are part of the system can be specialists from any discipline required by the patients (e.g., medical and health specialists, legal specialists, vocational and occupational specialists or any other specialists required by the chronically ill patient).

### Internet Embodiment

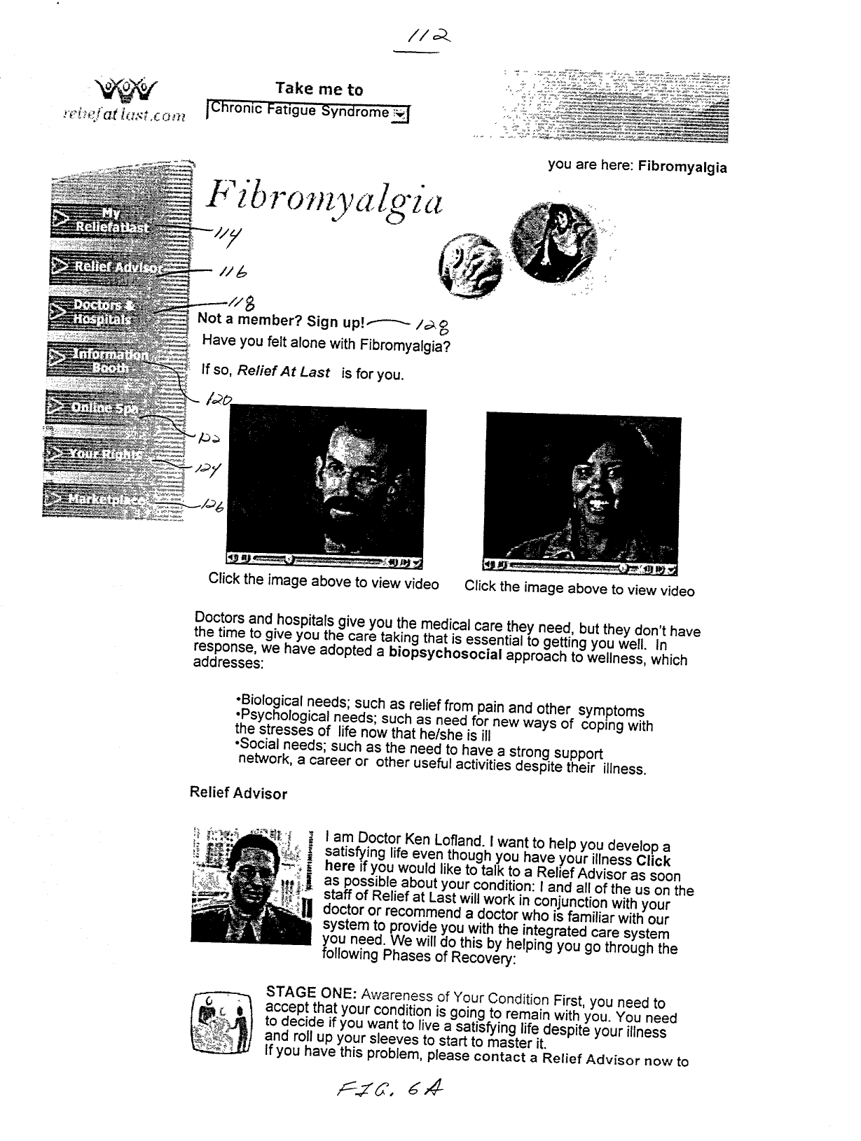

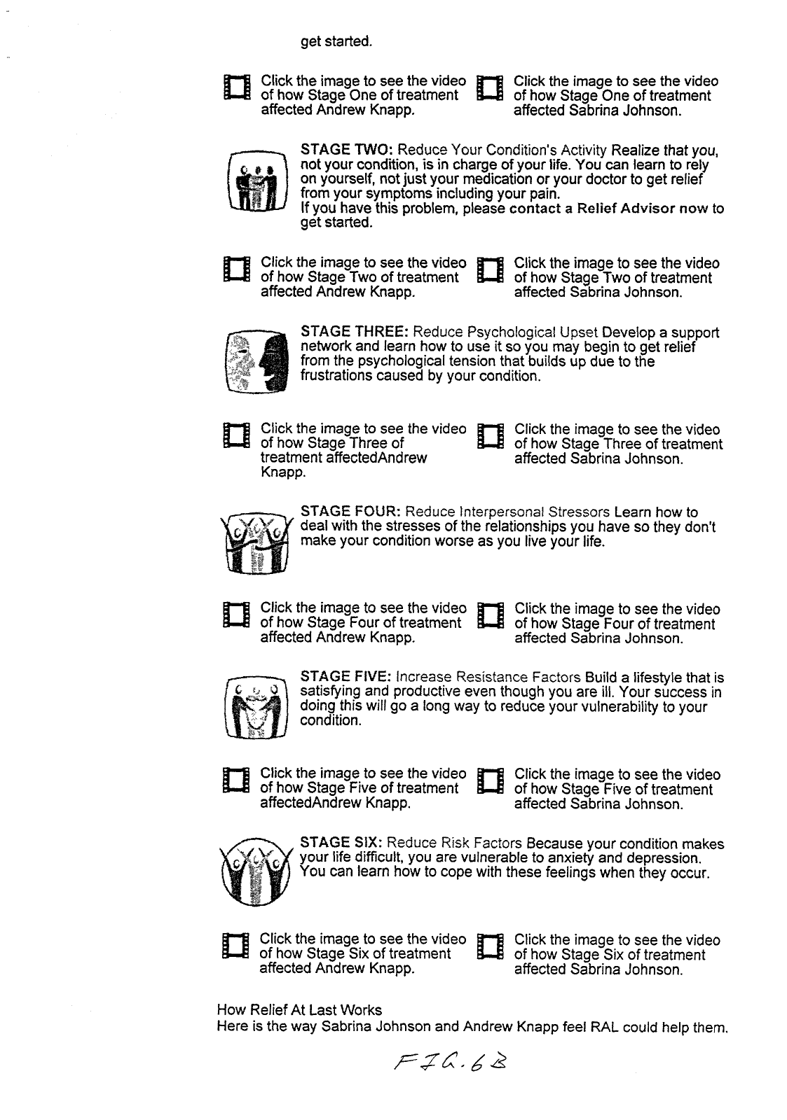

In a preferred embodiment of the invention, the invention is practiced over the internet through a web site. To initiate this embodiment, a potential treatment program user (a “user” may be the chronically ill person himself or the chronically ill person's caregiver) accesses the chronic disease relief program 16 through his or her workstation 18a. Upon accessing the chronic disease relief program 16, the program 16 generates a web page 100, similar to the one depicted in FIG. 5, which is displayed on the user's workstation 18a. The generated web page 100 allows the system user to choose from a number of chronic illnesses that the system provides support services for. In the embodiment depicted in FIG. 5, the system allows the user to choose between five selections (Chronic Fatigue Syndrome (CFS) 102, Early Alzheimers 104, Arthritis 106, Asthma & Chronic Obstructive Pulmonary Disease (COPD) 108 and Fibromyalgia 110). Although only these diseases are discussed herein, the invention is not so limited. It could be applied to any chronic illness.

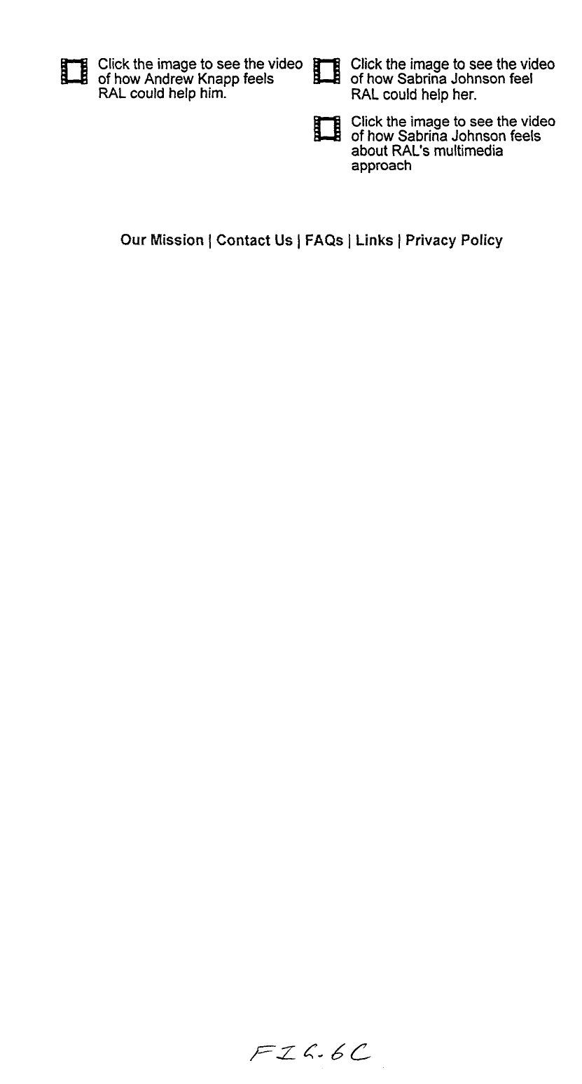

From the page 100, the user selects a disease that he or she is interested in. The disease selection is important because the site is divided by disease such that the content generated and the structure of the follow on pages is driven by the disease selected. The example described herein describes the operation of the site for the disease fibromyalgia. To select fibromyalgia, the user clicks on the “Fibromyalgia” button 110. The structure of the example fibromyalgia site described herein is representative of the structure of the other disease sites supported by the system 20. Upon clicking the “Fibromyalgia” button 110, a page 112 (FIGS. 6A-6C) is generated which explains the fibromyalgia web site and provides content directed specifically to fibromyalgia. The page 112, in addition to the content explaining the operation of the site and related fibromyalgia content, has a series of buttons that direct a user to other helpful resources. The “My Relief at Last” button 114 directs users to a page that is only for members of the treatment program and allows them to interact with their personal My Relief at Last web pages described in detail below. The “Relief Advisor” button 116 also directs users to a members only page which, once accessed, allows treatment program members a way to communicate with their personal, assigned relief advisor. In contrast to the first two buttons, the rest of the buttons direct users to pages that are available to the general public. The “Doctors & Hospitals” button 118 directs users to a page that provides users helpful resource information for selecting a doctor or hospital. The “Information Booth” button 120 directs users to a page that provides users with information on the selected disease, in this case information on fibromyalgia. The “Online Spa” button 122 directs users to a page that provides users with information on healthy living, such as information on fitness and exercise and on diet and nutrition. The “Your Rights” button 124 directs users to a page explaining their legal rights as individuals suffering with a chronic illness. The “Marketplace” button 126 directs users to a page where treatment items related to the selected disease may be purchased. General health-related items may also be purchased from this page.

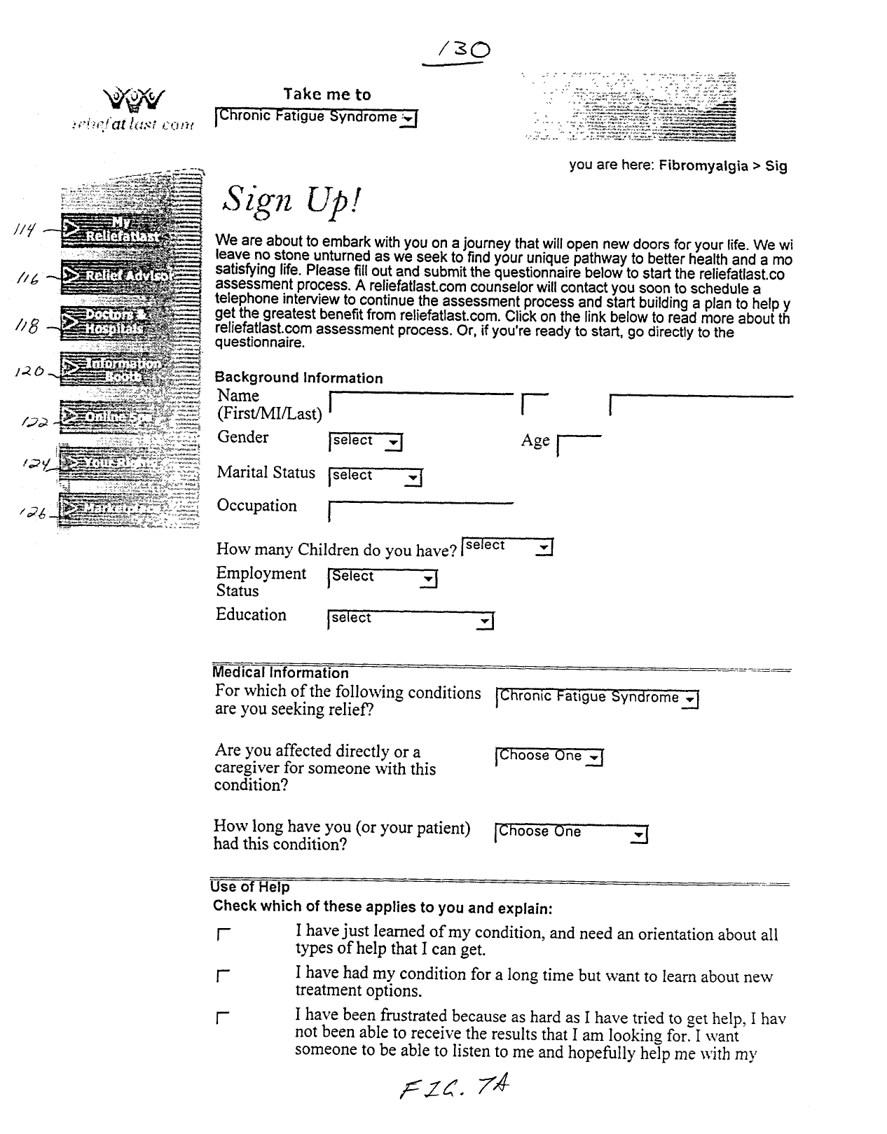

To join the treatment program offered by the page 112 in FIG. 6A, the user may click on the page at a number of places. One such place is the linked statement “Not a member? Sign up!” 128. Clicking on the linked statement 128 generates a member sign up page questionnaire 130 similar to the one depicted in FIGS. 7A-B. The sign up questionnaire 130 requests basic background information from the user so that the treatment program administrators can make an assessment of where the user is with his or her disease and whether the treatment program of the present invention will be of any value to them. Once the user has completed the sign up questionnaire, the user submits it to the chronic disease relief program 16 for processing. In response, the chronic disease relief program 16 generates an automatic reply e-mail which notifies the new registrant that the completed questionnaire was received and that he or she will be contacted shortly for a more detailed consultation. The chronic disease relief program 16 parses the information provided in the questionnaire and saves this information to the system database 14 and notifies the treatment program administrator of the new patient.

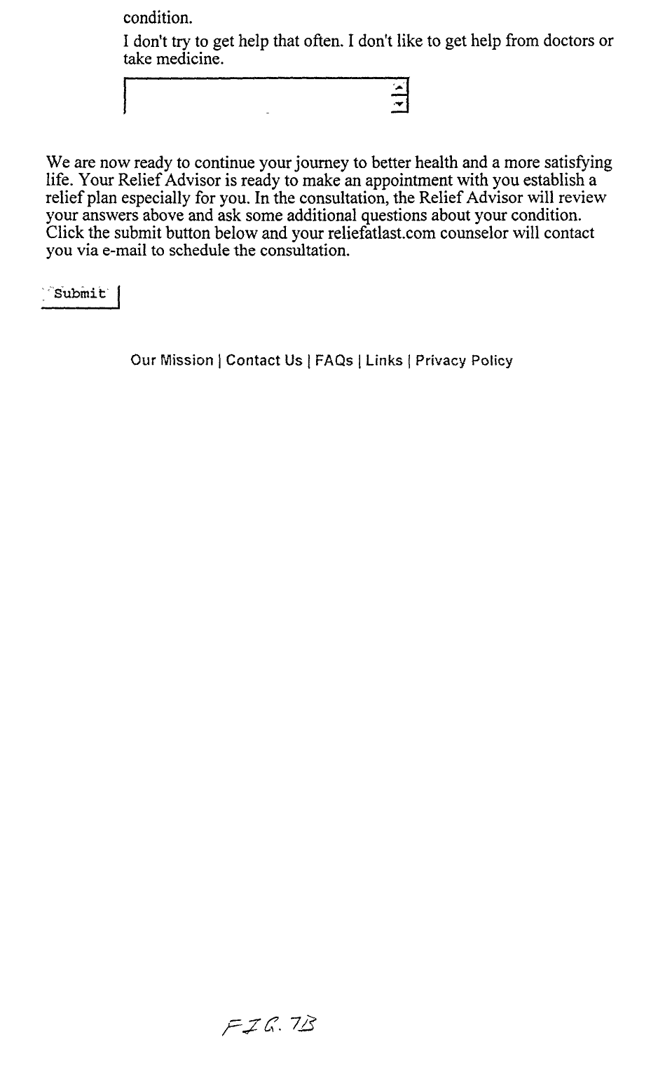

As discussed above, at this point, the treatment program administrator has a treatment program social worker contact the new patient to conduct an initial consultation interview and some self assessment tests. Once this is complete, a relief advisor is assigned who compiles the assessment data, analyzes it and provides the patient with a summary of the assessment 132, similar to the one depicted in FIG. 8. In this assessment, the relief advisor makes a determination as to what stage of the treatment plan the new patient is at (e.g., the patient has already come to terms with his or her disease and is ready to start taking steps to reduce disease activity) so he or she can place the patient at the appropriate level. Based on the assessment and using the summary, the relief advisor and the patient work together to develop a list of treatment goals, similar to the Phase 2 goals Janet has developed with her relief advisor in column 134 on FIG. 8. Depending on the particular implementation of the treatment program of the present invention, a majority of the tasks that the relief advisor is responsible for may be automated through the chronic disease relief program 16 with the relief advisor's role being more supervisory.

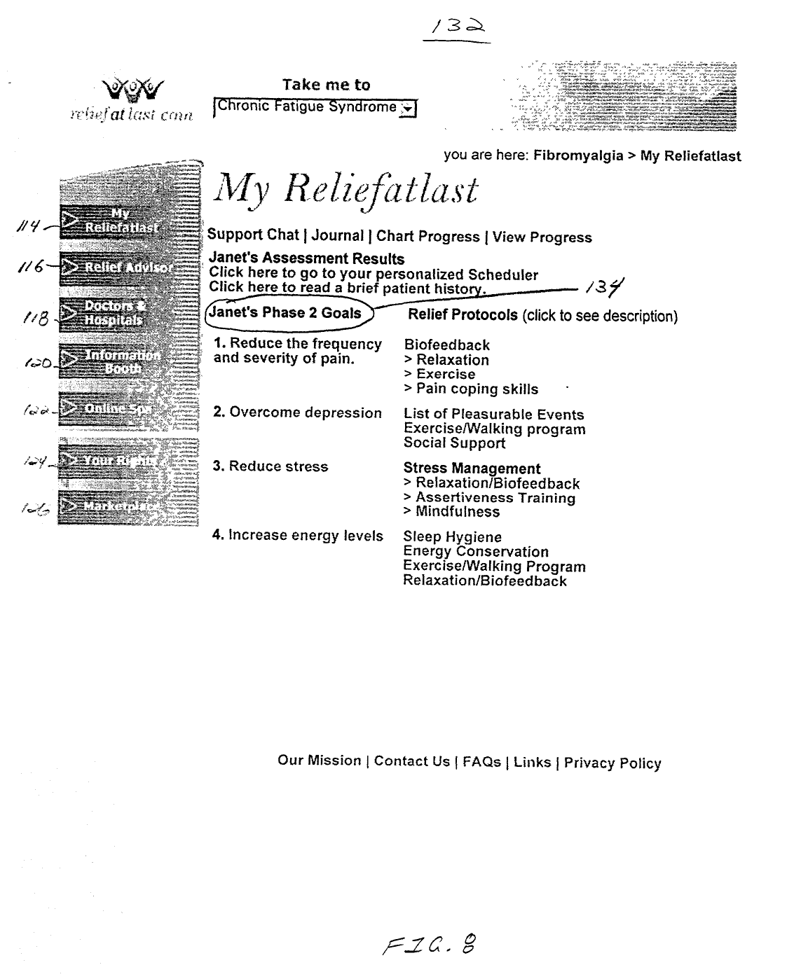

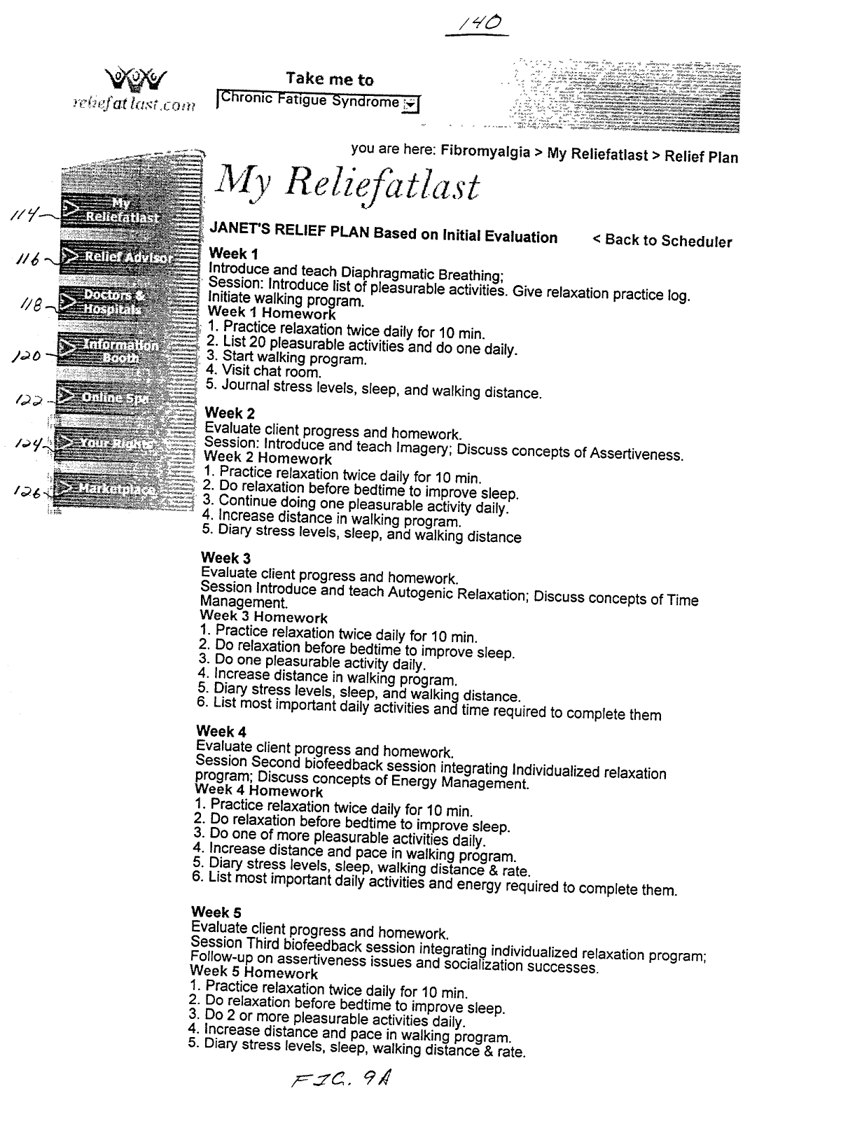

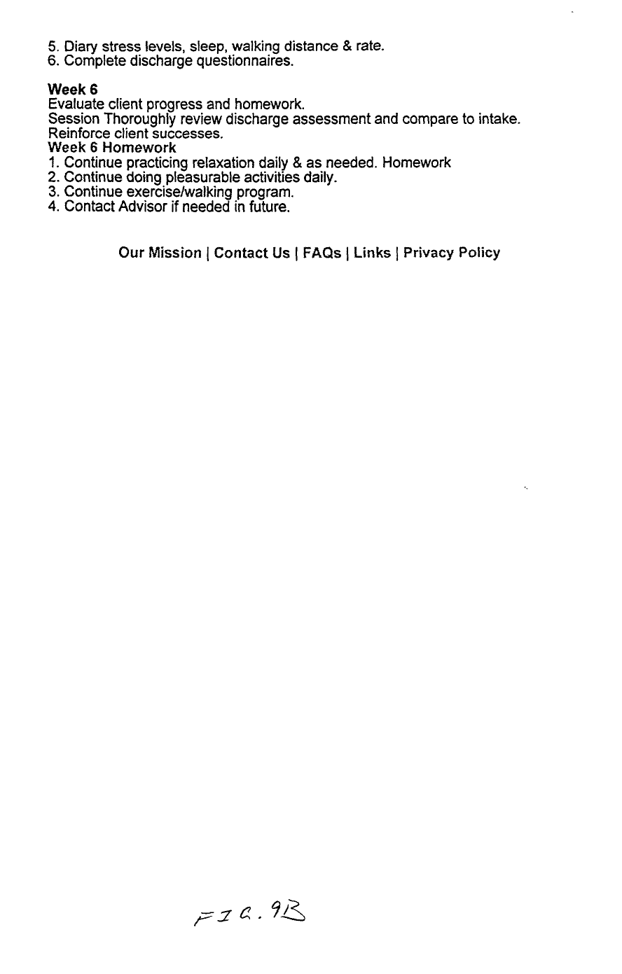

Using this list of goals as a guidepost, the relief advisor and the patient then develop and schedule on a weekly basis a set of activities that will achieve those goals. FIGS. 9A-B and 10 depict a sample activities list 140 and schedule 142, respectively. As FIG. 9A illustrates, the patient, Janet, and her relief advisor have determined that during her first week she should: 1) be introduced to diaphragmatic breathing; 2) prepare a list of pleasurable activities; 3) prepare a relaxation practice log and 4) start a walking program. Specifically, her homework for the first week includes practicing relaxation twice daily for 10 minutes, listing 20 pleasurable activities and doing at least one of them daily, starting a walking program, visiting a chat room and making a journal of her stress levels, her sleep and her distance walked. Referring to FIG. 10, all of these activities are scheduled by the chronic disease relief program 16, in conjunction with the relief advisor and Janet, for Janet on her personal schedule page 142.

### Conducting a Scheduled Activity

Referring to FIG. 10, the patient can keep track of his or her scheduled activities on his or her personal schedule page 142. When the time comes for the patient to conduct a scheduled activity, if the relief advisor is not required for the session, the patient can perform the required activity on his own. If the scheduled activity requires a relief advisor, the patient should consult with his or her relief advisor prior to the session so they can discuss the plans for the session, discuss the specific goals the patient has in mind for that session, discuss concerns or problems that the patient might have at the time and they can further discuss any suggestions the relief advisor might have on helping the patient optimize the session. If the patient misses a scheduled activity, the chronic disease relief program 16 generates an e-mail that is sent to the patient to notify him or her that he or she has missed a scheduled activity and that they need to re-schedule it. If agreed to by the patient, in addition to e-mails, these follow up notices may include the relief advisor calling the patient to follow up.

Scheduled activities can take a number of different forms (including even face-to face counseling with a program specialist if necessary), and they usually involve some mix of multimedia, interactive biopsychosocial treatment tools to accomplish the goals of the session. These multimedia, interactive treatment tools may include, among other things, video, video conferencing, audio, images, guided imagery presentations, text and other web-based technologies. For example, in a relaxation protocol, the patient sees a video and listens to background music which sets the tone for a relaxing environment. The patient gets to choose what video he or she wants to watch and what music he or she wants to listen to in this session. The treatment program also provides the patient with a number of other videos directed to helping the patient get the most out of the session. These videos may include videos from other patients, videos from experts, videos on the benefits of the session or videos on the best ways to benefit from the session.

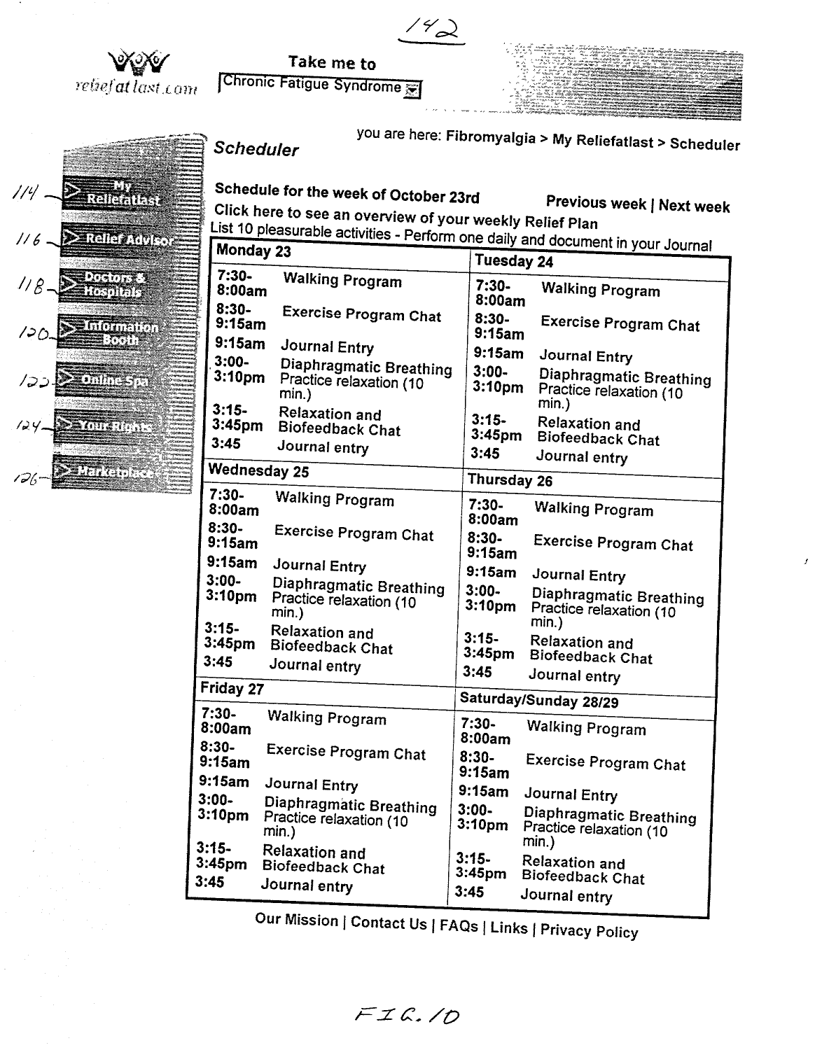

Referring again to FIG. 10, the session on Monday the 23d calling for introduction to and teaching of “Diaphragmatic Breathing” is a linked scheduled activity (e.g., an activity which is linked to something else such that when the patient clicks on the link, the patient is directed to some other support feature). By clicking on the text “Diaphragmatic Breathing”, the patient is directed to a treatment protocol 150, similar to the one depicted in FIG. 11, generated for the patient's use. Treatment protocols cover a wide range of interventions and cover a wide array of disciplines. For instance, there are psychotherapy based protocols, occupational and physical therapy protocols and social work based protocols, just to name a few. Treatment protocols are also directed to the address the issues for the patient at his or her particular stage of treatment. For instance, a patient learning to reduce the disease activity associated with his disease has different protocols than a person trying to accept the disease.

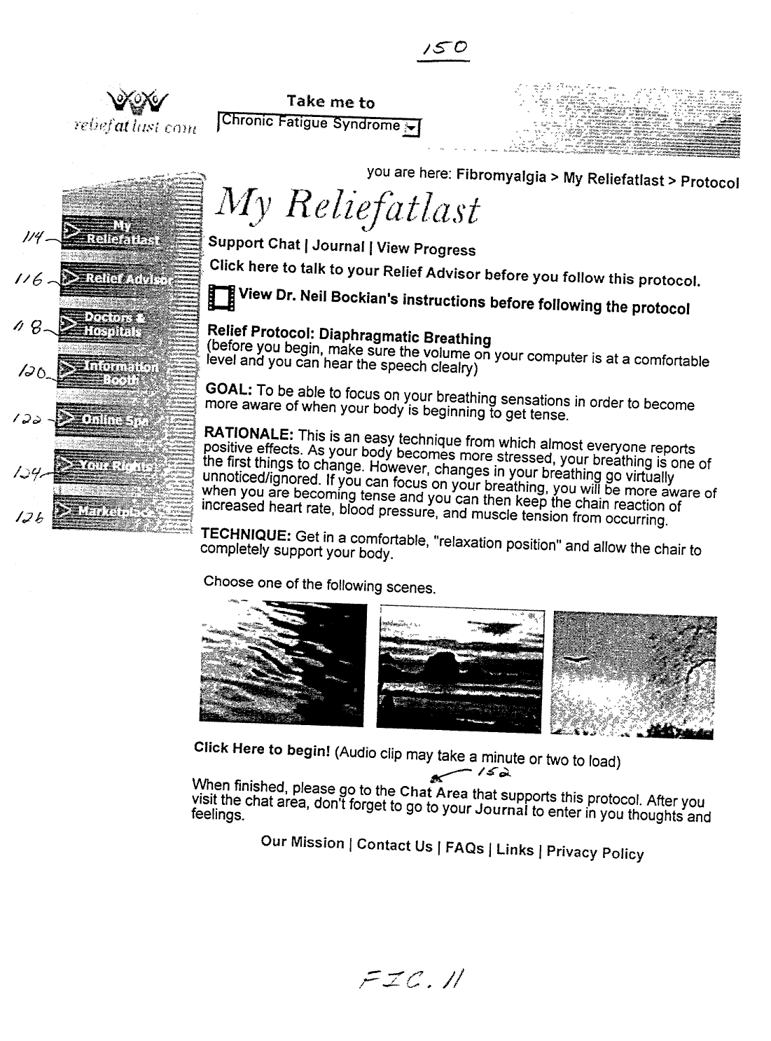

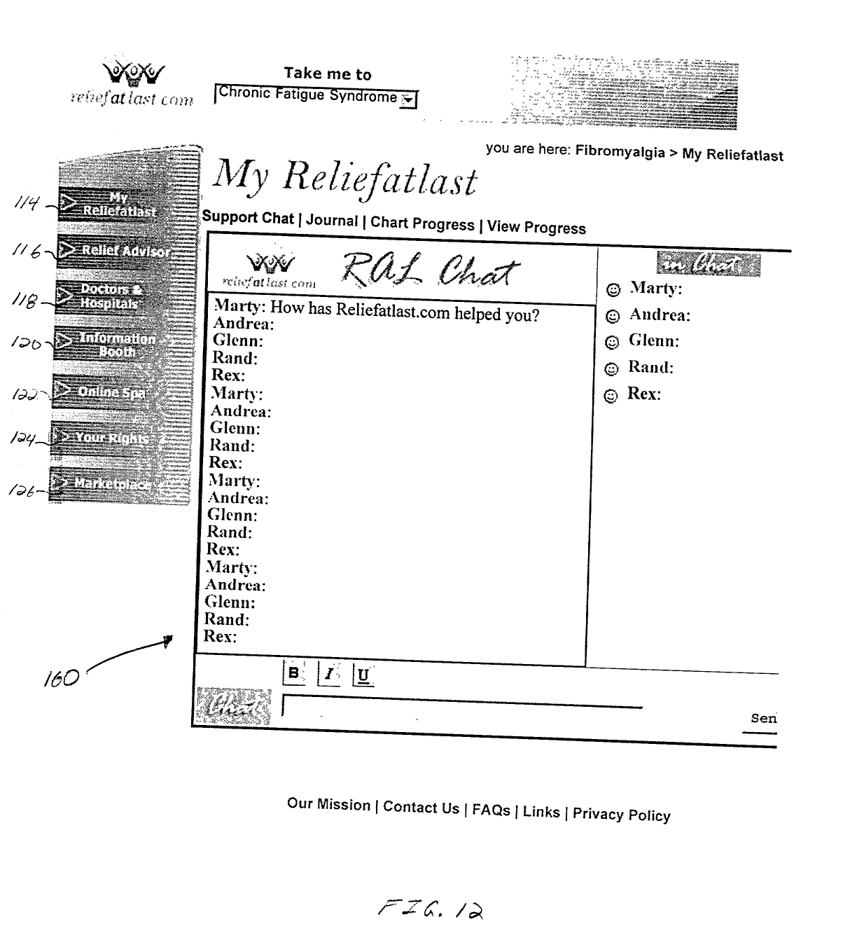

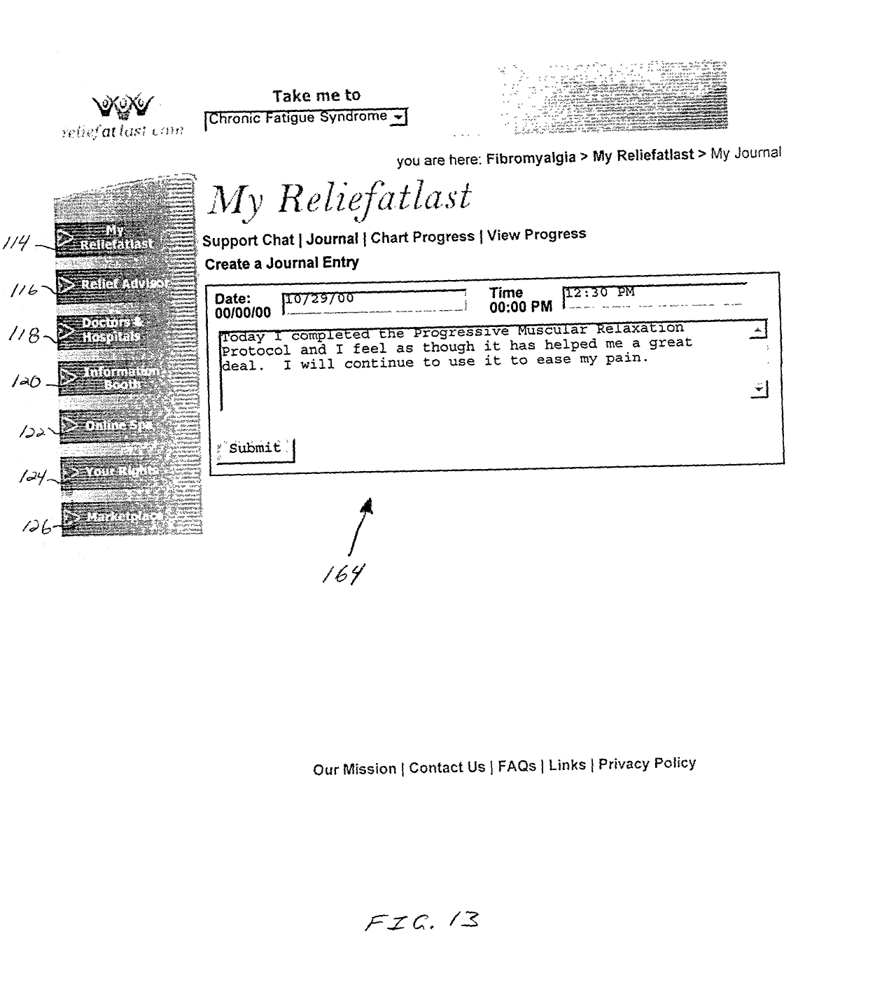

The relief protocol 150 provides the patient with the information necessary to conduct the scheduled activity. In the example of FIG. 11, the relief protocol 150 explains the goal of the exercise, explains the rationale for performing the exercise and explains the technique to be performed. It also provides a link to an audio clip to assist the patient in conducting this exercise. At the end of the exercise, as indicated at 152, the patient is instructed to go to the chat area that supports the protocol at issue. By clicking on the text “Chat Area”, the patient is directed to a chat room 160 similar to the one depicted in FIG. 12 which, in this example, supports the diaphragmatic breathing protocol. In a chat room such as this one directed to supporting a specific treatment protocol, only patients who have the disease specified and require the treatment addressed are allowed into the chat room. The chat discussion in these treatment specific chat rooms is lead by a relief advisor trained in the disease and the treatment protocol. Once the patient is done in the chat area discussing his or her treatment and treatment activities, the patient, as reminded on the relief protocol page (FIG. 11), should make an entry in his or her journal recording his or her thoughts and feelings or any other comments regarding the treatment or his or her progress. FIG. 13 illustrates a sample journal entry page 164. Recording the journal entry serves four main purposes: (i) it provides a written record that the patient can refer to later if he or she wishes; (ii) it forces the patient to reflect on the day's scheduled activities and evaluate their effectiveness, positive and negative, before moving on; (iii) it gives the relief advisor a way to track whether the patient is performing their scheduled activities or not and (iv) it gives the relief advisor a way to assess the patient's progress, or lack thereof, and a way to evaluate the effectiveness of the patient's planned treatment program and make modifications if necessary.

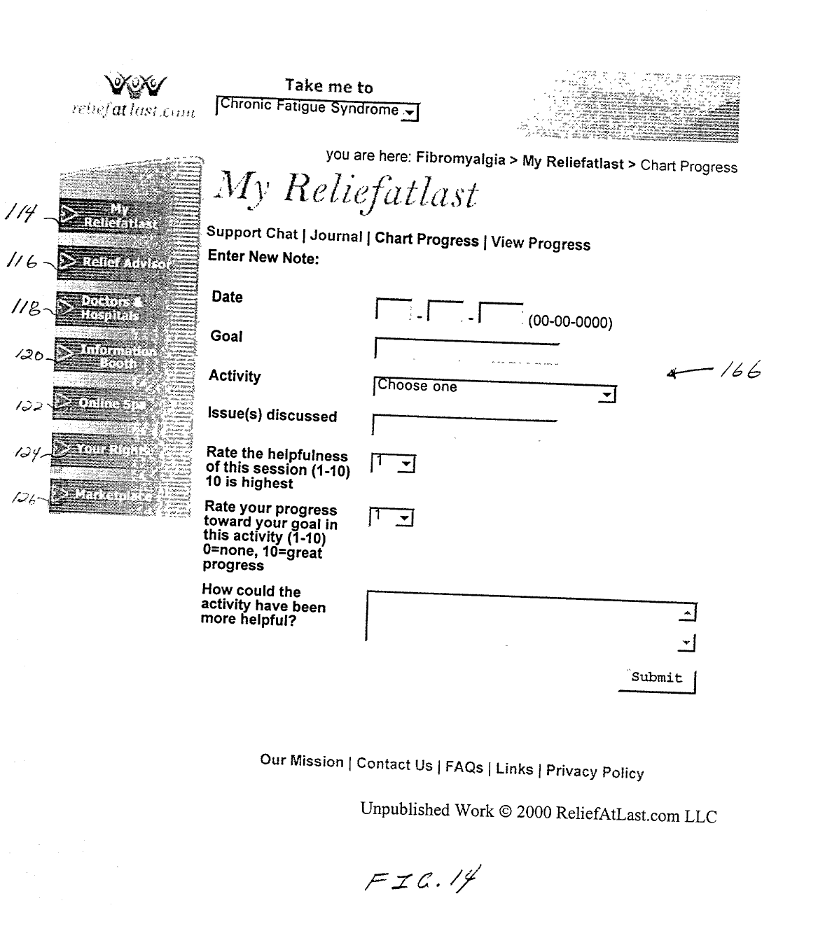

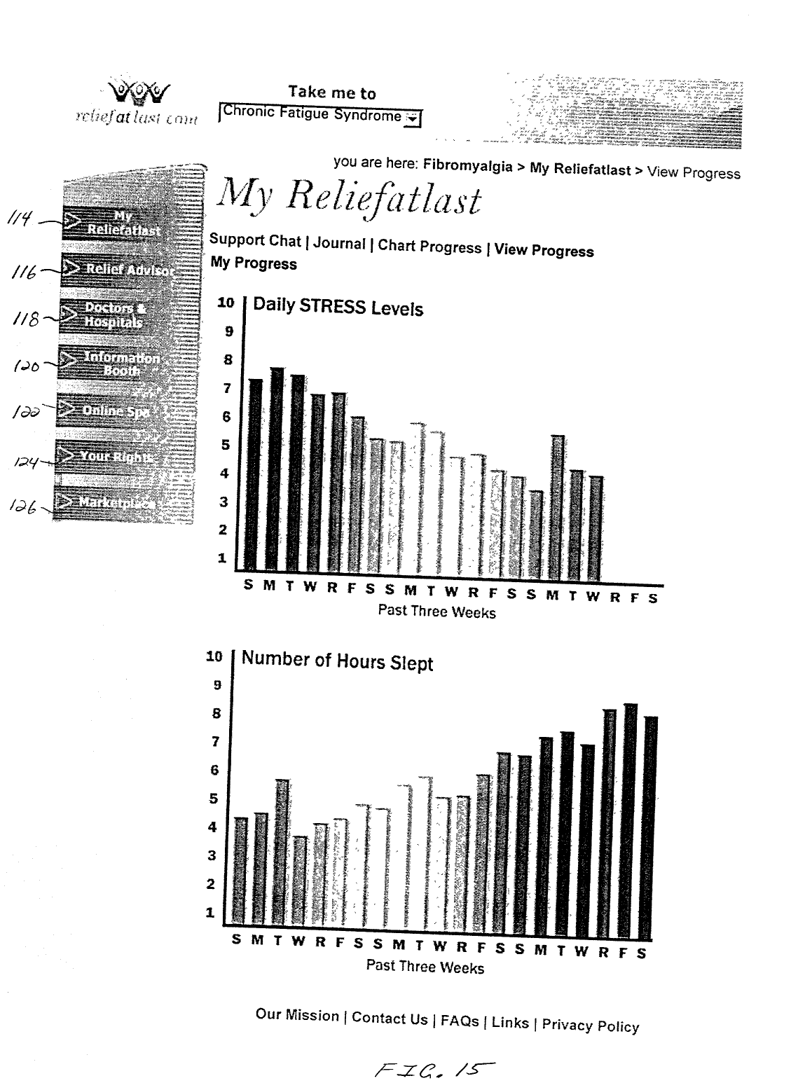

As depicted in FIG. 14, the patient also tracks his or her progress by entering such progress information into a data entry screen 166. As illustrated in FIG. 15, entry of this type of information gives the patient and the relief advisor a way to visually assess the patient's progress toward specific goals set by the patient and the relief advisor. When the patient achieves the stated goal, the patient is directed to an awards chat room where he or she is given awards and praise, usually by members of the patient's support network, such as family and friends.

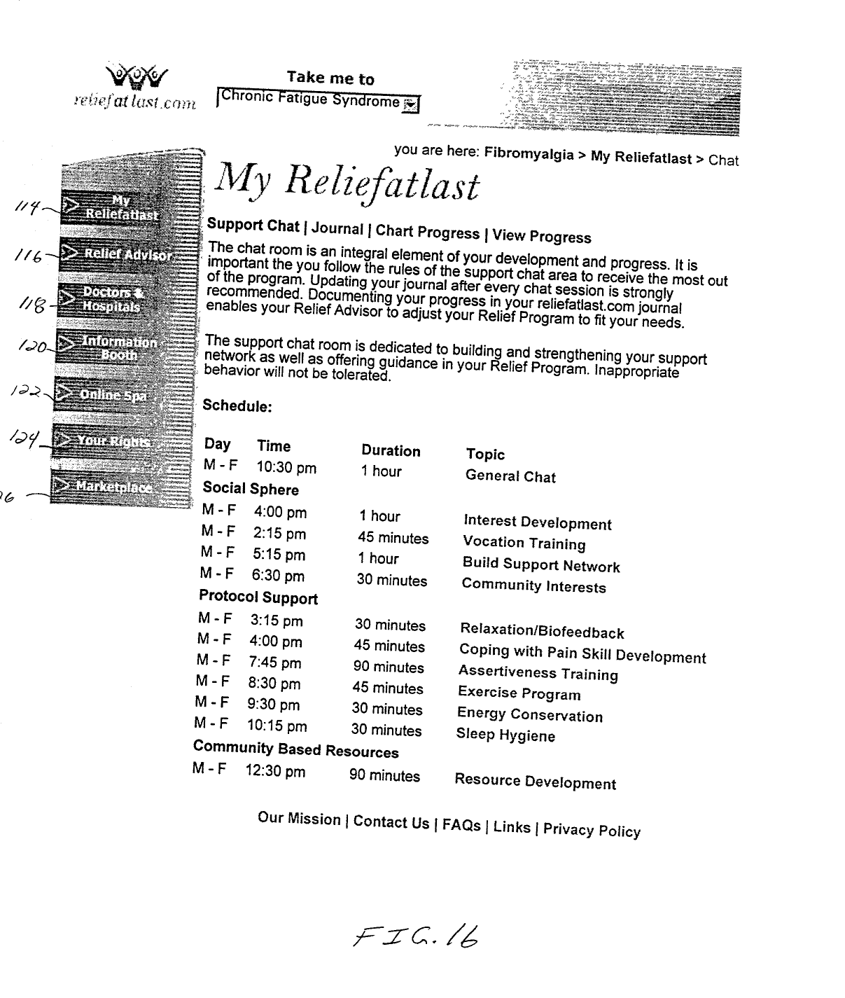

The treatment program of the present invention, in addition to treatment specific and award chat rooms described above, provides two other types of chat rooms as well. These two types of chat rooms are (i) chat rooms devoted to specific areas of interest or specific activities and (ii) chat rooms of general interest to the specific disease community. All of the chat rooms are divided by disease type to ensure that patients with similar concerns and interests are being put in touch with one another. The chat rooms devoted to specific areas of interest or specific activities are led by a specialist in that particular area of interest. For example, a chat room geared toward changing vocations would be led by a job training counselor. The final type of chat room, general interest chat rooms, in contrast to the treatment specific chat rooms and the specific area of interest chat rooms, are not led by anyone; rather, they are open forums where all members of the specific disease community may come to discuss general topics of interest, exchange comments, experiences and provide support to one another. FIG. 16 illustrates a sample page of chat rooms available to a fibromyalgia patient.

The “Marketplace ” feature 126 of the web site is another important aspect of the treatment program of the present invention. The “Marketplace” feature 126 allows the patient to purchase supplies and equipment needed for treating the disease directly from manufacturers and distributors through the site. Prior to this invention, much of this equipment would not be distributed to patients directly because manufacturers and distributors were concerned that the patients did not have enough training and expertise with the equipment to properly set it up and use it. With the present invention, the relief advisor, to the extent required, gets involved in the purchase, set up and use of the required equipment which allays the manufacturers and distributors concerns.

The system and method of the present invention also provide training for caregivers of people with chronic illnesses. This training follows the same six stages of treatment as for the patient's program, uses the same relief advisors and uses the same materials as the patient's program. The goals of this portion of the treatment program are to train the caregiver in how to optimize the effectiveness of the caregiving process, to provide the caregiver with auxiliary supports and to provide the caregiver with support and recognition for his or her role in the treatment process. For example, with a disease that deteriorates the brain, such as Alzheimers Disease, the primary focus of the treatment program is on the caregiver because the patient cannot effectively interact with the program himself.

While the invention has been discussed in terms of preferred and specific embodiments, it should be appreciated by those of skill in the art that the invention is not so limited. The embodiments are explained herein by way of example, and there are numerous modifications, variations and other embodiments that may be employed that would still be within the scope of the present invention.

What is claimed is:

1. A computer network based method for providing comprehensive, community-based treatment and related support services to chronically ill patients, comprising:
collecting data on the patient;
using the collected data to assess the patient's present stage of chronic illness;
using the assessment to develop at least one treatment goal appropriate for the assessed stage of chronic illness; and
using the developed treatment goal as a guide to develop at least one specified activity for achieving the specified goal.

2. The method of claim 1, further comprising conducting the specified activity.

3. The method of claim 1, further comprising providing a relief advisor, wherein the relief advisor is a trained counselor with expertise to address the needs of chronically ill patients.

4. The method of claim 3 wherein the patient and relief advisor work together to develop the at least one treatment goal and the at least one specified activity.

5. The method of claim 3 wherein a relief advisor is available to the patient at all times.

6. The method of claim 1 wherein the at least one specified activity is a multimedia, interactive treatment tool.

7. The method of claim 6 wherein the multimedia, interactive tool is a guided imagery presentation.

8. The method of claim 1 wherein the at least one specified activity is a chat room.

9. The method of claim 8 wherein the chat room is disease specific.

10. The method of claim 8 wherein the chat room is treatment specific.

11. The method of claim 1 wherein the at least one specified activity is a face-to-face counseling session.

12. The method of claim 1 wherein at least one specified activity is maintaining a journal.

13. The method of claim 1, further comprising scheduling the specified activity.

14. The method of claim 13, further comprising notifying the patient if the scheduled specified activity is missed.

15. The method of claim 2, further comprising providing a treatment protocol which provides the patient with the information necessary to conduct the specified activity.

16. The method of claim 2, further comprising tracking the patient's progress towards the developed treatment goal.

17. The method of claim 16, further comprising directing the patient to an awards chat room when the patient achieves the developed treatment goal.

18. The method of claim 1 wherein the chronic illness is chronic fatigue syndrome.

19. The method of claim 1 wherein the chronic illness is early Alzheimers.

20. The method of claim 1 wherein the chronic illness is arthritis.

22. The method of claim 1 wherein the chronic illness is asthma and chronic obstructive pulmonary disease.

23. The method of claim 1 wherein the chronic illness is fibromyalgia.

24. The method of claim 1, further comprising referring the patient to a patient support facility to see a specialist.

25. The method of claim 1, further comprising providing a marketplace wherein the patient can purchase supplies and equipment needed to treat the chronic illness.

26. The method of claim 25, further comprising providing instructions to the patient for supplies and equipment purchased at the marketplace.

27. A system for providing comprehensive, community-based treatment and related support services to chronically ill patients, comprising:
a computer system having a chronic disease relief program stored thereon for performing a method comprising storing collected data on the patient; using the collected data to assess the patient's present stage of chronic illness; using the assessment to develop at least one treatment goal appropriate for that stage of chronic illness; and using the developed treatment goal as a guide to develop at least one specified activity for achieving the specified goal.

28. The system of claim 27, further comprising a relief advisor, wherein the relief advisor is a trained counselor with expertise to address the needs of chronically ill patients.

29. The system of claim 28 wherein the patient and relief advisor work together to develop the at least one treatment goal and the at least one specified activity.

30. The system of claim 28 wherein a relief advisor is available to the patient at all times.

31. The system of claim 27 wherein the developed specified activity is a multimedia, interactive treatment tool stored on the computer system.

32. The system of claim 31 wherein the stored multimedia, interactive tool is a guided imagery presentation.

33. The system of claim 27 wherein the method performed by the chronic disease relief program includes generating a chat room.

34. The system of claim 33 wherein the generated chat room generated is disease specific.

35. The system of claim 33 wherein the generated chat room is treatment specific.

36. The system of claim 27 wherein the method performed by the chronic disease relief program includes generating and maintaining a journal.

37. The system of claim 27 wherein the method performed by the chronic disease relief program includes scheduling the specified activity.

38. The system of claim 37 wherein the method performed by the chronic disease relief program includes notifying the patient if the scheduled specified activity is missed.

39. The system of claim 27 wherein the method performed by the chronic disease relief program includes providing a treatment protocol which provides the patient with the information necessary to conduct the specified activity.

40. The system of claim 27 wherein the method performed by the chronic disease relief program includes tracking the patient's progress towards the developed treatment goal.

41. The system of claim 40 wherein the method performed by the chronic disease relief program includes directing the patient to an awards chat room when the patient achieves the developed treatment goal.

42. The system of claim 27 wherein the chronic illness is chronic fatigue syndrome.

43. The system of claim 27 wherein the chronic illness is early Alzheimers.

44. The system of claim 27 wherein the chronic illness is arthritis.

45. The system of claim 27 wherein the chronic illness is asthma and chronic obstructive pulmonary disease.

46. The system of claim 27 wherein the chronic illness is fibromyalgia.

47. The system of claim 27 wherein the method performed by the chronic disease relief program includes referring the patient to a patient support facility to see a specialist.

48. The system of claim 27 wherein the method performed by the chronic disease relief program includes generating a marketplace wherein the patient can purchase supplies and equipment needed to treat the chronic illness.

49. The system of claim 48 wherein the method performed by the chronic disease relief program includes generating instructions to the patient for the supplies and equipment purchased at the marketplace.

50. A system for providing comprehensive, community-based treatment and related support services for caregivers of chronically ill patients, comprising:
a computer system having a chronic disease relief program stored thereon for performing a method comprising storing collected data on the patient; using the collected data to assess the patient's present stage of chronic illness; using the assessment to develop at least one treatment goal appropriate for that stage of chronic illness; and using the developed treatment goal as a guide to develop at least one specified activity for achieving the specified goal.

51. The system of claim 50, further comprising a relief advisor, wherein the relief advisor is a trained counselor with expertise to assist the caregiver and address the needs of chronically ill patients.

52. The system of claim 51 wherein the caregiver and the relief advisor work together to develop the at least one treatment goal and the at least one specified activity.

53. The system of claim 51 wherein a relief advisor is available to the caregiver at all times.

54. The system of claim 50 wherein the developed specified activity is a multimedia, interactive treatment tool stored on the computer system.

55. The system of claim 54 wherein the stored multimedia, interactive tool is a guided imagery presentation.

56. The system of claim 50 wherein the method performed by the chronic disease relief program includes generating a chat room.

57. The system of claim 56 wherein the generated chat room generated is disease specific.

58. The system of claim 56 wherein the generated chat room is treatment specific.

59. The system of claim 50 wherein the method performed by the chronic disease relief program includes generating and maintaining a journal.

60. The system of claim 50 wherein the method performed by the chronic disease relief program includes scheduling the specified activity.

61. The system of claim 60 wherein the method performed by the chronic disease relief program includes notifying the caregiver if the scheduled specified activity is missed.

62. The system of claim 50 wherein the method performed by the chronic disease relief program includes providing a treatment protocol which provides the caregiver with the information necessary to assist the patient in conducting the specified activity.

63. The system of claim 50 wherein the method performed by the chronic disease relief program includes tracking the patient's progress towards the developed treatment goal.

64. The system of claim 50 wherein the chronic illness is chronic fatigue syndrome.

65. The system of claim 50 wherein the chronic illness is early Alzheimers.

66. The system of claim 50 wherein the chronic illness is arthritis.

67. The system of claim 50 wherein the chronic illness is asthma and chronic obstructive pulmonary disease.

68. The system of claim 50 wherein the chronic illness is fibromyalgia.

69. The system of claim 50 wherein the method performed by the chronic disease relief program includes referring the caregiver to a patient support facility so the patient can see a specialist.

70. The system of claim 50 wherein the method performed by the chronic disease relief program includes generating a marketplace wherein the caregiver can purchase supplies and equipment that the patient needs to treat the chronic illness.

71. The system of claim 70, wherein the method performed by the chronic disease relief program includes generating instructions to the caregiver for the supplies and equipment purchased for the patient at the marketplace.
